(19) United States
(12) Patent Application Publication
(10) Pub. No.: US 2020/0172032 A1
(43) Pub. Date: Jun. 4, 2020

(54) ON-VEHICLE POWER SUPPLY CIRCUIT AND ON-VEHICLE POWER SUPPLY APPARATUS

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(72) Inventors: Ibuki Kawamura, Yokkaichi, Mie (JP); Takafumi Kawakami, Yokkaichi, Mie (JP); Seiji Takahashi, Yokkaichi, Mie (JP)

(21) Appl. No.: 16/621,802

(22) PCT Filed: Jun. 8, 2018
(86) PCT No.: PCT/JP2018/022110

§ 371 Date: Dec. 12, 2019

(30) Foreign Application Priority Data
Jun. 28, 2017 (JP) 2017-125885

(51) Int. Cl. B60R 16/03; G06F 1/28; G06F 1/26; H02M 3/00

(52) U.S. Cl. CPC B60R 16/03; H02M 3/00; G06F 1/263; G06F 1/28

(57) ABSTRACT

An on-vehicle power supply circuit includes a first inner power supply unit that supplies power to a control unit based on power supplied from a first power storage unit, a second inner power supply unit that supplies power to the control unit based on power supplied from a second power storage unit, and an operation voltage adjustment unit. The operation voltage adjustment unit outputs an operation voltage to the control unit based on power from the second inner power supply unit when power supply from the second inner power supply unit is in a normal state, and outputs an operation voltage to the control unit based on power from the first inner power supply unit when power supply from the second inner power supply unit is not in a normal state.

### CROSS-REFERENCE TO RELATED APPLICATIONS

This application is the U.S. national stage of PCT/JP2018/022110 filed on Jun. 8, 2018, which claims priority of Japanese Patent Application No. JP 2017-125885 filed on Jun. 28, 2017, the contents of which are incorporated herein.

### TECHNICAL FIELD

The present disclosure relates to an on-vehicle power supply circuit and an on-vehicle power supply apparatus.

### BACKGROUND

JP2004-88906A discloses a technique related to a DC-DC converter that steps up or down a DC voltage by driving a switching element. This DC-DC converter includes a conversion circuit that converts a first DC voltage into a second DC voltage, and outputs the second DC voltage, a control circuit that controls operations of the conversion circuit, a power supply circuit that supplies power to the control circuit, and a power supply means that supplies power from the conversion circuit to the control circuit when a voltage applied from the power supply circuit to the control circuit decreases to a predetermined value or smaller.

In the DC-DC converter disclosed in JP2004-88906A, when an operation voltage that is supplied from the power supply circuit to the control circuit decreases to a predetermined value or smaller due to some cause, the control circuit continues to operate using power supplied from the conversion circuit to the control circuit. However, in order to perform such an auxiliary operation, the conversion circuit is required to operate properly, and, when the conversion circuit cannot generate sufficient power for the operation, the control circuit ceases to operate.

The present disclosure has been made in light of the above-described circumstances, and aims to provide a configuration with which, in a normal state, an operation voltage that is based on a specific power storage unit can be supplied to a control unit of an on-vehicle power supply apparatus, and, even when an abnormality occurs in which power supply from this power storage unit decreases or stops, an operation voltage can be continuously supplied to the control unit in a stable manner.

### SUMMARY

An on-vehicle power supply circuit of a first aspect of the present disclosure is used in an on-vehicle power supply apparatus that includes: a voltage conversion unit that steps up or down a voltage that is applied to a first conductive path electrically connected to a first power storage unit and applies the voltage to a second conductive path electrically connected to a second power storage unit; and a control unit that outputs a control signal to the voltage conversion unit. The power supply circuit includes: a first inner power supply unit that supplies power to the control unit based on power supplied from the first power storage unit; a second inner power supply unit that supplies power to the control unit based on power supplied from the second power storage unit; and an operation voltage adjustment unit that outputs an operation voltage to the control unit based on power from at least the second inner power supply unit when power supply from the second inner power supply unit is in a normal state, and outputs an operation voltage to the control unit based on power from at least the first inner power supply unit when power supply from the second inner power supply unit is not in the normal state.

An on-vehicle power supply apparatus of a second aspect of the present disclosure includes: the on-vehicle power supply circuit; the voltage conversion unit; and the control unit.

### Advantageous Effects

The on-vehicle power supply circuit of the first aspect includes an operation voltage adjustment unit, and can output an operation voltage to the control unit based on power from at least the second inner power supply unit when power supply from the second inner power supply unit is in a normal state, and output an operation voltage to the control unit based on power from at least the first inner power supply unit when power supply from the second inner power supply unit is not in the normal state. Accordingly, even when an abnormality occurs in which power supply from the second power storage unit decreases or stops, an operation voltage can be output to the control unit based on power from the first inner power supply unit, and thus an operation of supplying an operation voltage to the control unit can be stably continued. In addition, when an abnormality occurs, an operation voltage can be generated without largely depending on the voltage conversion unit, and thus an operation voltage is supplied to the control unit more stably.

The on-vehicle power supply apparatus of the second aspect has an effect similar to that of the on-vehicle power supply circuit of the first aspect.

### BRIEF DESCRIPTION OF DRAWINGS

FIG. 1 is a block diagram schematically illustrating an on-vehicle power supply system provided with an on-vehicle power supply circuit of a first embodiment.

FIG. 2 is a block diagram schematically illustrating a basic configuration related to a voltage conversion operation, in an on-vehicle power supply apparatus of the on-vehicle power supply system illustrated in FIG. 1.

### DETAILED DESCRIPTION OF PREFERRED EMBODIMENTS

Here, desirable examples of the present disclosure will be described.

The operation voltage adjustment unit may include a first output path that is a conductive path through which power is output from the first inner power supply unit, a second output path that is a conductive path through which power is output from the second inner power supply unit, an input path that is a conductive path through which an operation voltage is input to the control unit, a first diode whose anode is connected on the first output path side, and whose cathode is connected on the input path side, and a second diode whose anode is connected on the second output path side, and whose cathode is connected on the input path side.

With such a configuration, if power supply from the second inner power supply unit decreases or stops when power is being output from the first inner power supply unit and the second inner power supply unit, an operation voltage is immediately compensated for based on power from the first inner power supply unit. Thus, if power supply from the second inner power supply unit decreases or stops, it is possible to prevent an operation voltage for the control unit from being shut off for a long time.

The second inner power supply unit may apply a voltage of a predetermined second voltage value to the second output path, in the normal state. The first inner power supply unit may apply a voltage of a first voltage value that is lower than the second voltage value, to the first output path.

With such a configuration, in the normal state, a voltage in the second output path applied by the second inner power supply unit exceeds a voltage in the first output path applied by the first inner power supply unit, and an operation voltage can be provided to the control unit with priority given to power supply from the second inner power supply unit. Thus, it is possible to suppress power consumption of the first inner power supply unit and thus power consumption of the first power storage unit. Meanwhile, when power supply from the second inner power supply unit decreases or stops, an operation voltage is immediately compensated for based on power from the first inner power supply unit.

The on-vehicle power supply apparatus may also include a switch that switches between an on-state where power supply from the first power storage unit to the first inner power supply unit is permitted and an off-state where it is shut off, and a protection control unit that switches the switch to an on-state if a value of an output voltage that is output from the first inner power supply unit is smaller than a threshold value, and switches the switch to an off-state if the value is larger than or equal to the threshold value.

With such a configuration, in an overvoltage state where the value of an output voltage that is output from the first inner power supply unit is higher than or equal to the threshold, it is possible to stop output from the first inner power supply unit. Thus, it is possible prevent a negative effect caused by an overvoltage state, and it is also possible to prevent a situation where power supply from the first inner power supply unit is prioritized when power supply from the second inner power supply unit is in the normal state.

The on-vehicle power supply apparatus may include a switch that switches between an on-state where power supply from the first power storage unit to the first inner power supply unit is permitted and an off-state where it is shut off, and a switch change unit that switches the switch to an on-state when the control unit causes the voltage conversion unit to operate, and switches the switch to an off-state when the control unit does not cause the voltage conversion unit to operate.

With such a configuration, when the control unit does not cause the voltage conversion unit to operate, in other words, when the need to supply power from the first inner power supply unit to the control unit is very low, it is possible to stop the first inner power supply unit, and it is possible to effectively suppress power consumption of the first power storage unit.

### First Embodiment

A first embodiment that embodies the present disclosure will be described below.

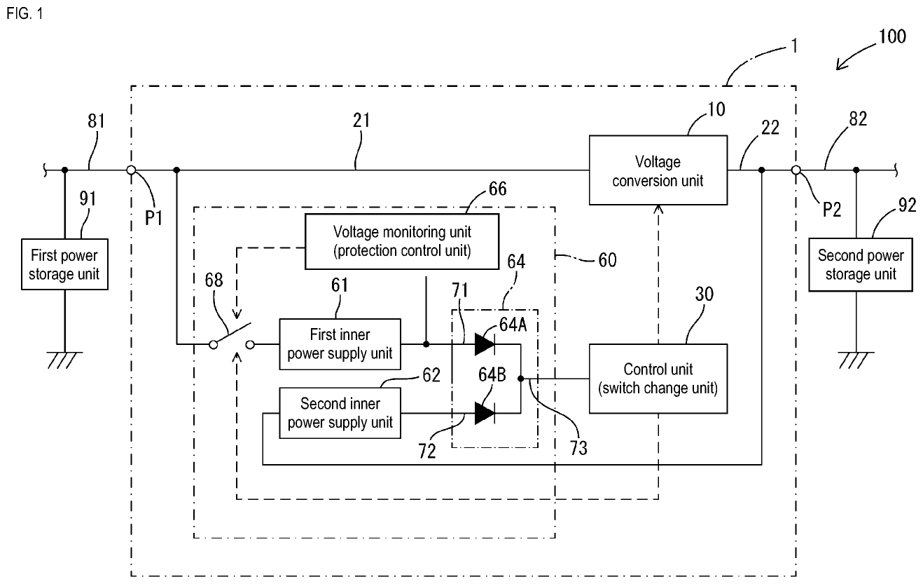

An on-vehicle power supply system 100 shown in FIG. 1 is configured as a system that includes a first power storage unit 91 and a second power storage unit 92 each configured as an on-vehicle power storage unit, and an on-vehicle power supply apparatus 1 (hereinafter, also referred to as “power supply apparatus 1”) configured as an on-vehicle DC-DC converter. The power supply system 100 can supply power to on-vehicle loads (not illustrated) mounted in the vehicle. An on-vehicle load that is supplied with power from the power supply apparatus 1 is provided and electrically connected to a wire 82 on the low-voltage side in most cases, and an on-vehicle load may be provided and electrically connected to a wire 81 on the high-voltage side. Note that the types of these on-vehicle loads are not particularly limited, and known various loads that can be mounted in a vehicle can be provided.

The first power storage unit 91 is constituted by a power storage means such as an electric double layer capacitor or a lithium ion battery, and generates a first predetermined voltage. For example, a terminal of the first power storage unit 91 on the high-potential side is kept at about 48 V, and a terminal on the low-potential side is kept at the ground potential (0 V). The terminal of the first power storage unit 91 on the high-potential side is electrically connected to the wire 81 provided in the vehicle, and the first power storage unit 91 applies a predetermined voltage to the wire 81. The terminal of the first power storage unit 91 on the low-potential side is electrically connected to a reference conductive path configured as a ground portion in the vehicle. The wire 81 is connected to a terminal P1 of the power supply apparatus 1 on the high-voltage side, and is electrically connected to a first conductive path 21 via the high-voltage terminal P1.

The second power storage unit 92 is constituted by a power storage means such as a lead storage battery, and generates a second predetermined voltage that is lower than the first predetermined voltage that is generated by the first power storage unit 91. For example, a terminal of the second power storage unit 92 on the high-potential side is kept at about 12 V and a terminal on the low-potential side is kept at the ground potential (0 V). The terminal of the second power storage unit 92 on the high-potential side is electrically connected to the wire 82 provided in the vehicle, and the second power storage unit 92 applies a predetermined voltage to the wire 82. The terminal of the second power storage unit 92 on the low-potential side is electrically connected to a reference conductive path configured as a ground portion in the vehicle. The wire 82 is connected to a terminal P2 of the power supply apparatus 1 on the low-voltage side, and is electrically connected to a second conductive path 22 via the low-voltage terminal P2.

The power supply apparatus 1 is configured as an on-vehicle DC-DC converter that is mounted in a vehicle for use, and can perform a basic operation of stepping down a DC voltage applied to a conductive path on the high-voltage side (the first conductive path 21), and outputting the voltage to a conductive path on the low-voltage side (the second conductive path 22). Furthermore, the power supply apparatus 1 can perform a basic operation of stepping up a DC voltage applied to the conductive path on the low-voltage side (the second conductive path 22), and outputting the voltage to the conductive path on the high-voltage side (the first conductive path 21).

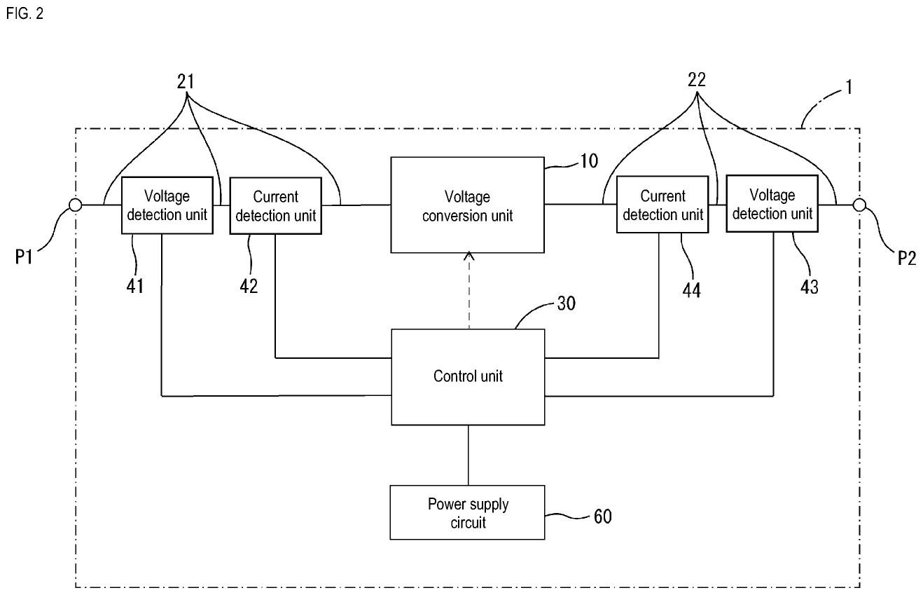

As shown in FIG. 2, the power supply apparatus 1 mainly includes the first conductive path 21, the second conductive path 22, a voltage conversion unit 10, a control unit 30, a voltage detection unit 41, a current detection unit 42, a voltage detection unit 43, a current detection unit 44, the high-voltage terminal P1, the low-voltage terminal P2, and the like.

The first conductive path 21 is configured as a power supply line on the primary side (high-voltage side) on which a relatively high voltage is applied. A configuration is adopted in which the first conductive path 21 is electrically connected to the terminal of the first power storage unit 91 on the high-potential side via the wire 81, and a predetermined DC voltage is applied from the first power storage unit 91 to the first conductive path 21. In the configuration in FIG. 1, the high-voltage terminal P1 is provided at the end of the first conductive path 21, and the wire 81 is electrically connected to this high-voltage terminal P1.

The second conductive path 22 is configured as a power supply line on the secondary side (low voltage side) on which a relatively low voltage is applied. A configuration is adopted in which the second conductive path 22 is electrically connected to the terminal of the second power storage unit 92 on the high-potential side via the wire 82, and a DC voltage smaller than an output voltage of the first power storage unit 91 is applied from the second power storage unit 92 to the second conductive path 22. In the configuration in FIG. 1, the low-voltage terminal P2 is provided at the end of the second conductive path 22, and the wire 82 is electrically connected to this low-voltage terminal P2.

The voltage conversion unit 10 is configured as a step-up/down DC-DC converter that can perform bidirectional voltage conversion. The voltage conversion unit 10 is a main part of a switching DC-DC converter, and, when a step-down control signal (step-down PWM signal) is provided from the control unit 30, steps down a DC voltage applied to the conductive path on the high-voltage side (the first conductive path 21), and applies an output voltage to the conductive path on the low-voltage side (the second conductive path 22). When a step-up control signal (step-up PWM signal) is provided from the control unit 30, the voltage conversion unit 10 steps up a DC voltage applied to the conductive path on the low-voltage side (the second conductive path 22), and applies an output voltage to the conductive path on the high voltage side (the first conductive path 21).

The voltage detection unit 41 is configured as a known voltage detection circuit that can input a value indicating a voltage in the first conductive path 21, to the control unit 30, and, for example, may also be configured as a voltage-dividing circuit that divides a voltage in the first conductive path 21 and inputs a resulting voltage to the control unit 30, or may also be a circuit that inputs a voltage in the first conductive path 21 directly to the control unit 30. Similarly, the voltage detection unit 43 may be configured as a known voltage detection circuit that can input the value indicating a voltage in the second conductive path 22 to the control unit 30, and, for example, may also be configured as a voltage-dividing circuit that divides a voltage in the second conductive path 22 and inputs the resulting voltage to the control unit 30, or may also be a circuit that inputs a voltage in the second conductive path 22 directly to the control unit 30.

The current detection unit 42 is configured as a known current detection circuit, and outputs a value indicating a current flowing through the first conductive path 21 (specifically, an analog voltage that is based on the value of a current flowing through the first conductive path 21). Similarly, the current detection unit 44 is configured as a known current detection circuit, and outputs a value indicating a current flowing through the second conductive path 22 (specifically, an analog voltage that is based on the value of a current flowing through the second conductive path 22). Detection values from the current detection units 42 and 44 are input to the control unit 30.

The control unit 30 includes a control circuit and a drive circuit, for example. The control circuit is configured as a microcomputer, for example, and is provided with a CPU that performs various computing processes, a ROM that stores information such as programs, a RAM that stores information that is temporarily generated, an A/D converter that converts an analog voltage that has been input into a digital value, and the like. Detection signals from the voltage detection units 41 and 43 (analog voltage signals corresponding to detected voltages) and detection signals from the current detection units 42 and 44 (analog voltage signals corresponding to detected currents) are provided to the A/D converter.

When causing the voltage conversion unit 10 to perform a step-down operation, the control unit 30 performs a feedback calculation so as to approximate a voltage that is applied to the second conductive path 22 to a set target value while causing the voltage detection unit 43 to detect a voltage in the second conductive path 22, and generates a PWM signal. Specifically, if the voltage in the second conductive path 22 detected by the voltage detection unit 43 is smaller than the target value, the duty ratio is increased through a feedback calculation so as to approximate to the target value, and if the voltage in the second conductive path 22 detected by the voltage detection unit 43 is larger than the target value, the duty ratio is adjusted and decreased through a feedback calculation so as to approximate to the target value. The PWM signal of the adjusted duty ratio is provided to the voltage conversion unit 10 by the drive circuit. Similarly, when causing the voltage conversion unit 10 to perform a step-up operation, the control unit 30 performs a feedback calculation so as to approximate a voltage that is applied to the first conductive path 21 to a set target value while causing the voltage detection unit 41 to detect a voltage in the first conductive path 21, and generates a PWM signal. Specifically, if the voltage in the first conductive path 21 detected by the voltage detection unit 41 is smaller than the target value, the duty ratio is increased through a feedback calculation so as to approximate the duty ratio to the target value, and if the voltage in the first conductive path 21 detected by the voltage detection unit 41 is larger than the target value, the duty ratio is adjusted and decreased through a feedback calculation so as to approximate the duty ratio to the target value. The PWM signal of the adjusted duty ratio is provided to the voltage conversion unit 10 by the drive circuit.

Next, an on-vehicle power supply circuit 60 (hereinafter, also referred to as “power supply circuit 60”) will be described with reference to FIG. 1.

The power supply circuit 60 shown in FIG. 1 is a circuit for generating an operation voltage to be provided to the control unit 30. The control unit 30 is configured to be capable of operating using an input path 73 as a power supply line and using a voltage that is applied to the input path 73 as a power supply voltage.

The power supply circuit 60 includes a first inner power supply unit 61 that supplies power to the control unit 30 based on power supplied from the first power storage unit 91, a second inner power supply unit 62 that supplies power to the control unit 30 based on power supplied from the second power storage unit 92, and an operation voltage adjustment unit 64 that adjusts an operation voltage to be provided to the control unit 30.

The first inner power supply unit 61 is configured as, for example, a known series power supply circuit configured based on an in-series power supply method or a known switching power supply circuit configured based on a switching power supply method, and steps down a voltage applied to the first conductive path 21 (a voltage that is input via a switch 68), and applies an output voltage of a first voltage value that is lower than the voltage in the first conductive path 21, to a first output path 71 to be described later. Note that any power supply circuit that has such a stepping down function can be used, and there is no limitation on the type thereof. The output voltage of the first inner power supply unit 61 is the potential difference between the first output path 71 and a ground (not illustrated), and output of the first inner power supply unit 61 is controlled such that the value of this potential difference reaches the first voltage value. The first voltage value, which is the value of the output voltage that is applied to the first output path 71 by the first inner power supply unit 61, is lower than a second voltage value, which is the value of the output voltage that is applied to a second output path 72 by the second inner power supply unit 62, and is lower than the rated voltage of the second power storage unit 92. In addition, the first voltage value is higher than a voltage value of the input path 73 that enables the control unit 30 to operate (lowest operable voltage). Note that a certain control circuit may perform a control operation of the first inner power supply unit 61, and, in this case, the control circuit may be configured to be capable of operating based on power from the first power storage unit 91.

It suffices for the second inner power supply unit 62 to have a circuit configuration that enables a DC voltage (output voltage) higher than the first voltage value to be applied to the second output path 72. A configuration is adopted in which the output voltage of the second inner power supply unit 62 is the potential difference between the second output path 72 and a ground (not illustrated), and the value of this potential difference is the second voltage value. The second inner power supply unit 62 is configured to apply, to the second output path 72, a voltage that is approximately the same as the voltage that is applied to the second conductive path 22, for example, and an example will be described below in which the second inner power supply unit 62 is configured as a conduction path that electrically connects the second conductive path 22 and the anode of a second diode 64B, as a representative example. Note that the second inner power supply unit 62 is not limited to this representative example, and may also be configured as a known series power supply circuit configured based on an in-series power supply method or a known switching power supply circuit configured based on a switching power supply method, for example, and may also be configured to step up or down a voltage applied to the second conductive path 22, and apply, to the second output path 72, an output voltage of the second voltage value that is higher or lower than the voltage in the second conductive path 22.

The second inner power supply unit 62 is configured to apply a voltage of a predetermined second voltage value to the second output path 72 in a normal state. “A normal state of the second inner power supply unit 62” refers to a state where the value of the voltage that is applied to the second output path 72 by the second inner power supply unit 62 is higher than the value of the voltage on the input path 73 that enables the control unit 30 to operate (lowest operable voltage), and specifically a state where the value of the voltage that is applied to the second output path 72 is higher than the first voltage value (the value of an output voltage that is applied to the first output path 71 in a state where the first inner power supply unit 61 is operating).

The operation voltage adjustment unit 64 operates so as to output an operation voltage to the control unit 30 based on power from the second inner power supply unit 62 when power supply from the second inner power supply unit 62 is in the above-described “normal state”, and output an operation voltage to the control unit 30 based on power from the first inner power supply unit 61 when power supply from the second inner power supply unit 62 is not in the normal state. This operation voltage adjustment unit 64 includes the first output path 71, which is a conductive path through which power is output from the first inner power supply unit 61, the second output path 72, which is a conductive path through which power is output from the second inner power supply unit 62, the input path 73, which is a conductive path through which an operation voltage is input to the control unit 30, a first diode 64A whose anode is connected on the first output path 71 side, and whose cathode is connected on the input path 73 side, and the second diode 64B whose anode is connected on the second output path 72 side, and whose cathode is connected on the input path 73 side.

In this operation voltage adjustment unit 64, if the value of a voltage that is applied to the second output path 72 by the second inner power supply unit 62 is larger than the value of a voltage that is applied to the first output path 71 by the first inner power supply unit 61, a current flows from the second inner power supply unit 62 to the input path 73 via the second output path 72 and the second diode 64B, and a current from the first inner power supply unit 61 does not flow to the input path 73. Accordingly, a voltage that is based on power that is supplied from the second inner power supply unit 62 is applied to the input path 73, and this voltage is an operation voltage that is provided to the control unit 30.

On the other hand, in the operation voltage adjustment unit 64, if the value of a voltage that is applied to the second output path 72 by the second inner power supply unit 62 is smaller than the value of a voltage that is applied to the first output path 71 by the first inner power supply unit 61, a current flows from the first inner power supply unit 61 to the input path 73 via the first output path 71 and the first diode 64A, and a current from the second inner power supply unit 62 does not flow to the input path 73. Accordingly, a voltage that is based on power that is supplied from the first inner power supply unit 61 is applied to the input path 73, and this voltage is an operation voltage that is provided to the control unit 30.

The switch 68 is constituted by a semiconductor switch element or a mechanical relay, and is configured to switch between an on-state where power supply from the first power storage unit 91 to the first inner power supply unit 61 is permitted and an off-state where it is shut off. In the example in FIG. 1, one end of the switch 68 is connected to the first conductive path 21, and the other end is connected to the first inner power supply unit 61. On/off of this switch 68 is controlled by a voltage monitoring unit 66 and the control unit 30. Specifically, when an off-signal is output from at least one of the voltage monitoring unit 66 and the control unit 30 to the switch 68, the switch 68 performs an off-operation. When an on-signal is output from both the voltage monitoring unit 66 and the control unit 30 to the switch 68, the switch 68 performs an on-operation.

Next, control that is performed in the power supply apparatus 1 will be described.

In the power supply apparatus 1 configured in this manner, the control unit 30 causes the voltage conversion unit 10 to perform a step-down operation according to a predetermined step-down condition being satisfied (for example, a condition under which an ignition switch switches from an off-state to an on-state being satisfied). Specifically, the control unit 30 causes the voltage conversion unit 10 to perform a step-down operation while adjusting the duty ratio of a PWM signal (step-down control signal) by repeating a feedback calculation such that the voltage in the second conductive path 22 reaches a desired target voltage, based on the voltage in the second conductive path 22 monitored by the voltage detection unit 43. In addition, the control unit 30 causes the voltage conversion unit 10 to perform a step-up operation according to a predetermined step-up condition being satisfied. Specifically, the control unit 30 causes the voltage conversion unit 10 to perform a step-up operation while adjusting the duty ratio of a PWM signal (step-up control signal) by repeating a feedback calculation such that a voltage in the first conductive path 21 reaches a desired target voltage, based on the voltage in the first conductive path 21 monitored by the voltage detection unit 41.

In the power supply circuit 60, regardless of whether the ignition switch is in an off-state or on-state, power from the second power storage unit 92 is supplied to the second inner power supply unit 62. Therefore, regardless of whether the ignition switch is in an off-state or on-state, in a situation where power supply from the second power storage unit 92 is performed as normal, the second inner power supply unit 62 applies an operation voltage that is based on power from the second power storage unit 92, to the input path 73.

With the configuration in FIG. 1, the control unit 30 functions as a switch change unit, and sets the switch 68 to an on-state for a period during which the control unit 30 causes the voltage conversion unit 10 to operate (for example, a period during which the ignition switch is in an on-state), and sets the switch 68 to an off-state for a period during which the control unit 30 does not cause the voltage conversion unit 10 to operate (for example, a period during which the ignition switch is in an off-state). The first inner power supply unit 61 does not perform an output operation during a period during which the control unit 30 causes the voltage conversion unit 10 to operate (for example, a period during which the ignition switch is in an on-state), and performs an output operation during a period during which the control unit 30 does not cause the voltage conversion unit 10 to operate (for example, a period during which the ignition switch is in an off-state).

With this configuration, for example, for a period during which the ignition switch is in an on-state, an output voltage of the first voltage value is applied from the first inner power supply unit 61 to the first output path 71, and, if the second inner power supply unit 62 is in the above-described normal state, a voltage of the second voltage value is applied to the second output path 72. In this case, the second voltage value that is applied to the second output path 72 by the second inner power supply unit 62 is larger than the first voltage value that is applied to the first output path 71 by the first inner power supply unit 61, and thus a current flows from the second inner power supply unit 62 to the input path 73 via the second output path 72 and the second diode 64B, and a current from the first inner power supply unit 61 does not flow to the input path 73. Accordingly, a voltage that is based on power supplied from the second inner power supply unit 62 is applied to the input path 73, and this voltage is an operation voltage that is provided to the control unit 30.

On the other hand, if the value of a voltage that is applied from the second inner power supply unit 62 to the second output path 72 decreases below the second voltage value for some reason when an output voltage of the first voltage value is being applied from the first inner power supply unit 61 to the first output path 71, a current immediately flows from the first inner power supply unit 61 to the input path 73 via the first output path 71 and the first diode 64A. Accordingly, a voltage that is based on power supplied from the first inner power supply unit 61 is applied to the input path 73, and this voltage is an operation voltage that is provided to the control unit 30. In this case, a current from the second inner power supply unit 62 does not flow to the input path 73.

In addition, the voltage monitoring unit 66 functions as an example of a protection control unit, and monitors the value of a voltage that is applied to the first output path 71 (the value of an output voltage that is output from the first inner power supply unit 61). If the value of an output voltage output from the first inner power supply unit 61, namely the value of a voltage that is applied to the first output path 71, is smaller than a threshold voltage, the voltage monitoring unit 66 performs control so as to output an on-signal to the switch 68 and switch the switch 68 to an on-state. In this case, if an on-signal is output from the control unit 30 to the switch 68 as well, the switch 68 is kept in the on-state. On the other hand, if the value of a voltage that is applied to the first output path 71 is larger than or equal to the threshold voltage, the voltage monitoring unit 66 outputs an off-signal to the switch 68, and switches the switch to an off-state. Note that the threshold voltage that is set for the voltage monitoring unit 66 is set higher than the above-described second voltage value and the rated voltage of the second power storage unit 92, for example, and is set lower than the rated voltage of the first power storage unit 91.

An effect of this configuration will be illustrated below.

The above-described on-vehicle power supply circuit 60 includes the operation voltage adjustment unit 64, and can output an operation voltage to the control unit 30 based on power from at least the second inner power supply unit 62 when power supply from the second inner power supply unit 62 is in a normal state, and output an operation voltage to the control unit 30 based on power from at least the first inner power supply unit 61 when power supply from the second inner power supply unit 62 is not in a normal state. Accordingly, even when an abnormality occurs in which power supply from the second power storage unit 92 decreases or stops, an operation voltage can be output to the control unit 30 based on power from the first inner power supply unit 61, and thus it is possible to stably continue an operation of supplying an operation voltage to the control unit 30. In addition, when an abnormality occurs, an operation voltage can be generated without largely depending on the voltage conversion unit 10, and thus an operation voltage can be supplied to the control unit 30 more stably.

The operation voltage adjustment unit 64 includes the first output path 71 that is a conductive path through which power from the first inner power supply unit 61 is output, the second output path 72 that is a conductive path through which power from the second inner power supply unit 62 is output, the input path 73 that is a conductive path through which an operation voltage is input to the control unit 30, a first diode whose anode is connected on the first output path 71 side, and whose cathode is connected on the input path 73 side, and a second diode whose anode is connected on the second output path 72 side, and whose cathode is connected on the input path 73 side. With such a configuration, if power supply from the second inner power supply unit 62 decreases or stops when power is being output from the first inner power supply unit 61 and the second inner power supply unit 62, an operation voltage is immediately compensated for based on power from the first inner power supply unit 61. Thus, if power supply from the second inner power supply unit 62 decreases or stops, it is possible to prevent an operation voltage for the control unit 30 from being shut off for a long time.

The second inner power supply unit 62 is configured to apply a voltage of a predetermined second voltage value to the second output path 72, in a normal state. The first inner power supply unit 61 is configured to apply a voltage of a first voltage value that is lower than the second voltage value to the first output path 71. With such a configuration, in a normal state, a voltage in the second output path 72 that is applied by the second inner power supply unit 62 exceeds a voltage in the first output path 71 that is applied by the first inner power supply unit 61, and an operation voltage can be provided to the control unit 30 with priority given to power supply from the second inner power supply unit 62. Thus, it is possible to suppress power consumption of the first inner power supply unit 61 and thus power consumption of the first power storage unit 91. On the other hand, when power supply from the second inner power supply unit 62 decreases or stops, an operation voltage is immediately compensated for based on power from the first inner power supply unit 61.

The power supply apparatus 1 includes the switch 68 that switches between an on-state where power supply from the first power storage unit 91 to the first inner power supply unit 61 is permitted and an off-state where it is shut off, and a protection control unit that switches the switch 68 to an on-state when the value of an output voltage that is output from the first inner power supply unit 61 is smaller than a threshold, and switches the switch 68 to an off-state when the value is larger than or equal to the threshold. Specifically, the voltage monitoring unit 66 functions as a protection control unit. With such a configuration, in an overvoltage state where the value of an output voltage that is output from the first inner power supply unit 61 is higher than or equal to the threshold, output from the first inner power supply unit 61 can be stopped. Thus, it is possible to prevent a negative effect caused by an overvoltage state, and it is also possible to prevent a situation where power supply from the first inner power supply unit 61 is prioritized when power supply from the second inner power supply unit 62 is in a normal state.

The power supply apparatus 1 includes a switch change unit that switches the switch 68 to an off-state when the control unit 30 does not cause the voltage conversion unit 10 to operate. Specifically, the control unit 30 functions as the switch change unit. With such a configuration, when the control unit 30 does not cause the voltage conversion unit 10 to operate, in other words, when the need to supply power from the first inner power supply unit 61 to the control unit 30 is very small, the first inner power supply unit 61 can be stopped, and power consumption of the first power storage unit 91 can be suppressed effectively.

The power supply system 100 shown in FIGS. 1 and 2 has a configuration in which a starter is electrically connected to a conductive path connected to the voltage conversion unit 10, and is configured such that a starter control apparatus (not illustrated) can cause the starter to operate based on power supply from the second power storage unit 92. In this system, when the output from the second power storage unit 92 has decreased, the starter cannot operate normally, and thus, in such a case (for example, when an output voltage from the second power storage unit 92 has decreased to a predetermined threshold voltage or smaller), an auxiliary operation of causing the starter to operate using power from the first power storage unit 91 on the high voltage side may be performed. However, under the assumption that the control unit 30 operates only using power from the second power storage unit 92, if output of the second power storage unit 92 decreases, the control unit 30 will not operate normally, and there is a risk that a starter operation cannot be performed. In contrast, in the above-described configuration, even if output of the second power storage unit 92 decreases, the control unit 30 can operate based on power from the first power storage unit 91, and thus it is possible to suppress the risk that a starter operation cannot be performed.

### Other Embodiments

The present disclosure is not limited to the embodiment described above and with reference to the drawings, and, can be realized with various modifications without departing from the gist of the disclosure. In addition, the above-described embodiment and modified examples to be described later can be combined to the extent that there is no contradiction. Moreover, for example, embodiments such as the following are included in the technical scope of the present disclosure.

In the first embodiment, a DC-DC converter in which the voltage conversion unit 10 has a single-phase structure has been illustrated as an example of an on-vehicle power supply apparatus, but a multi-phase DC-DC converter may also be adopted in which a plurality of voltage conversion units 10 are connected in parallel between a first conductive path 21 and a second conductive path 22.

In the first embodiment, an example has been illustrated in which a power supply apparatus is configured as a DC-DC converter that can perform a step-down operation of stepping down a voltage applied to a first conductive path, and applying the resulting voltage to a second conductive path, and a step-up operation of stepping up a voltage applied to the second conductive path, and applying the resulting voltage to the first conductive path, but a configuration may also be adopted in which the power supply apparatus only performs a step-down operation of stepping down a voltage applied to the first conductive path and applying the resulting voltage to the second conductive path. In addition, there is no limitation to these configurations, and the power supply apparatus may also be configured as any known DC-DC converter provided with a control unit.

1. An on-vehicle power supply circuit that is used in an on-vehicle power supply apparatus that includes:
a voltage conversion unit that steps up or down a voltage that is applied to a first conductive path electrically connected to a first power storage unit and applies the voltage to a second conductive path electrically connected to a second power storage unit, and
a control unit that outputs a control signal to the voltage conversion unit,
the on-vehicle power supply circuit comprising:
a first inner power supply unit that supplies power to the control unit based on power supplied from the first power storage unit;
a second inner power supply unit that supplies power to the control unit based on power supplied from the second power storage unit; and
an operation voltage adjustment unit that outputs an operation voltage to the control unit based on power from at least the second inner power supply unit when power supply from the second inner power supply unit is in a normal state, and outputs an operation voltage to the control unit based on power from at least the first inner power supply unit when power supply from the second inner power supply unit is not in the normal state.

2. The on-vehicle power supply circuit according to claim 1,
wherein the operation voltage adjustment unit includes:
a first output path that is a conductive path through which power is output from the first inner power supply unit,
a second output path that is a conductive path through which power is output from the second inner power supply unit,
an input path that is a conductive path through which an operation voltage is input to the control unit,
a first diode whose anode is connected on the first output path side, and whose cathode is connected on the input path side, and
a second diode whose anode is connected on the second output path side, and whose cathode is connected on the input path side.

3. The on-vehicle power supply circuit according to claim 2,
wherein the second inner power supply unit applies a voltage of a predetermined second voltage value to the second output path, in the normal state, and
the first inner power supply unit applies a voltage of a first voltage value that is lower than the second voltage value, to the first output path.

4. An on-vehicle power supply apparatus comprising:
the on-vehicle power supply circuit according to claim 1;
the voltage conversion unit; and
the control unit.

5. The on-vehicle power supply apparatus according to claim 4, further comprising:
a switch that switches between an on-state where power supply from the first power storage unit to the first inner power supply unit is permitted and an off-state where it is shut off; and
a protection control unit that switches the switch to an on-state if a value of an output voltage that is output from the first inner power supply unit is smaller than a threshold value, and switches the switch to an off-state if the value is larger than or equal to the threshold value.

6. The on-vehicle power supply apparatus according to claim 4, further comprising:
a switch that switches between an on-state where power supply from the first power storage unit to the first inner power supply unit is permitted and an off-state where it is shut off; and
a switch change unit that switches the switch to an on-state when the control unit causes the voltage conversion unit to operate, and switches the switch to an off-state when the control unit does not cause the voltage conversion unit to operate.

7. The on-vehicle power supply apparatus set forth in claim 4, wherein the operation voltage adjustment unit includes:
a first output path that is a conductive path through which power is output from the first inner power supply unit,
a second output path that is a conductive path through which power is output from the second inner power supply unit,
an input path that is a conductive path through which an operation voltage is input to the control unit,
a first diode whose anode is connected on the first output path side, and whose cathode is connected on the input path side, and
a second diode whose anode is connected on the second output path side, and whose cathode is connected on the input path side.

8. The on-vehicle power supply apparatus set forth in claim 4, wherein the second inner power supply unit applies a voltage of a predetermined second voltage value to the second output path, in the normal state, and
the first inner power supply unit applies a voltage of a first voltage value that is lower than the second voltage value, to the first output path.
